(19) United States
(12) Patent Application Publication
(10) Pub. No.: US 2019/0005116 A1
(43) Pub. Date: Jan. 3, 2019

(54) INFORMATION PROCESSING APPARATUS, INFORMATION PROCESSING SYSTEM AND INFORMATION PROCESSING METHOD

(71) Applicant: FUJITSU LIMITED, Kawasaki-shi (JP)

(72) Inventors: HISATOSHI YAMAOKA, Kawasaki (JP); Miwa Okabayashi, Sagamihara (JP)

(73) Assignee: FUJITSU LIMITED, Kawasaki-shi (JP)

(21) Appl. No.: 16/023,709

(22) Filed: Jun. 29, 2018

(30) Foreign Application Priority Data
Jul. 3, 2017 (JP) 2017-130425

(51) Int. Cl. G06F 17/30

(52) U.S. Cl. CPC G06F 17/30601; H04L 67/12

(57) ABSTRACT

An information processing apparatus, includes: a memory; and a processor coupled to the memory, wherein the processor: refers to actual result data of first events transmitted from a sensor; removes, from the actual result data, second events in which a sensor value belongs to a region of interest of a pass filter used for filtering; and generates, based on a number of third events in one or more clusters of distribution of the second events, a cut filter including a region of interest corresponding to a shape of the one or more clusters.

### CROSS-REFERENCE TO RELATED APPLICATION

This application is based upon and claims the benefit of priority of the prior Japanese Patent Application No. 2017-130425, filed on Jul. 3, 2017, the entire contents of which are incorporated herein by reference.

### FIELD

The embodiment relates to an information processing apparatus, an information processing system and an information processing method.

### BACKGROUND

An Internet of things (IoT) platform that aggregates events collected from an IoT device into a server or the like and processes the events is provided.

Examples of the related art include Japanese Laid-open Patent Publication No. 2005-141466 or Japanese Laid-open Patent Publication No. 2009-163753.

### SUMMARY

According to an aspect of the embodiments, an information processing apparatus, includes: a memory; and a processor coupled to the memory, wherein the processor: refers to actual result data of first events transmitted from a sensor; removes, from the actual result data, second events in which a sensor value belongs to a region of interest of a pass filter used for filtering; and generates, based on a number of third events in one or more clusters of distribution of the second events, a cut filter including a region of interest corresponding to a shape of the one or more clusters.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an example of a functional configuration of each apparatus included in an IoT system;

FIGS. 2, 3A and 3B depict an example of a filtering process;

FIG. 4 depicts an example of a region of interest;

FIG. 5 depicts an example of a cut filter;

FIG. 6 depicts an example of a histogram;

FIGS. 7A to 7D depict an example of a two-dimensional scatter diagram of events;

FIG. 8 depicts an example of a generation process of a cut filter;

FIG. 9 depicts an example of a functional configuration of each apparatus included in a different IoT system;

FIGS. 10 and 11 depict an example of a filtering process; and

FIG. 12 depicts an example of a hardware configuration of a computer that executes an information processing program.

### DESCRIPTION OF EMBODIMENT

For example, in an IoT platform, a messaging foundation that transfers sensor data transmitted from an IoT device to a module that demands the sensor data is utilized. In such a messaging foundation as just described, a filtering process is sometimes executed upon relaying of a message.

For example, in a message foundation of the data issuance-subscription type, for example, of the Pub/Sub type, a region in which a subscriber (Subscriber) of data is interested is set as a pass filter by a broker (Broker). Further, the Broker executes a filtering process for events transmitted from an issuer (Publisher) of data and transfers events that belong to the region of interest to the Subscriber.

In the case where such a filtering process as described above is executed, the load on the filtering process may increase together with increase of the number of filters set by the Broker or of the frequency by which an event is issued by the Publisher. This sometimes causes exhaustion of a hardware resource of the Broker such as a processor or a memory and decreases the throughput of data processed by the Broker, and as a result, an event may not be transferred rapidly to the Subscriber.

Therefore, in order to reduce the load on the filtering process in the Broker, before filtering in which a pass filter is used, filtering is sometimes executed using a primary filter generated by clustering a plurality of pass filters. Upon generation of the primary filter, regions of interest that overlap with or are positioned closely to each other between pass filters are aggregated into a cluster. Since filtering in which a pass filter is used is omitted for an event of a sensor value that does not belong to any region of interest of the primary filter, the number of times of filtering may be reduced.

For example, there may be a case in which it is still difficult to reduce the load on the filtering process.

For example, while the region of interest of the pass filter described above is set through a command for each Subscriber, regions of interest may not necessarily overlap with or be positioned closely to each other between pass filters. For example, in the case where the regions of interest of the pass filters are dispersed, a difference is less likely to occur between the number of clusters into which the regions of interest of the pass filters are clustered, for example, the number of primary filters, and the number of pass filters. If, under such a situation as just described, sensor values of events transmitted from the Publisher are concentrated on the outside the regions of interest of the primary filters, filtering is executed for each primary filter of numbers that does not have a great difference from the number of pass filters. In this case, since the number of times of execution of filtering is not different from that in the case where filtering is executed for each pass filter, the number of times of filtering in the Broker may not be reduced.

Although a filtering process of the Broker in which a message foundation of the Pub/Sub type is utilized is taken as an example, also in the filtering process in which a message foundation is not utilized, it may not be possible to reduce the load on the calculation process.

For example, an information processing apparatus or the like in which the load of a filtering process is reduced may be provided.

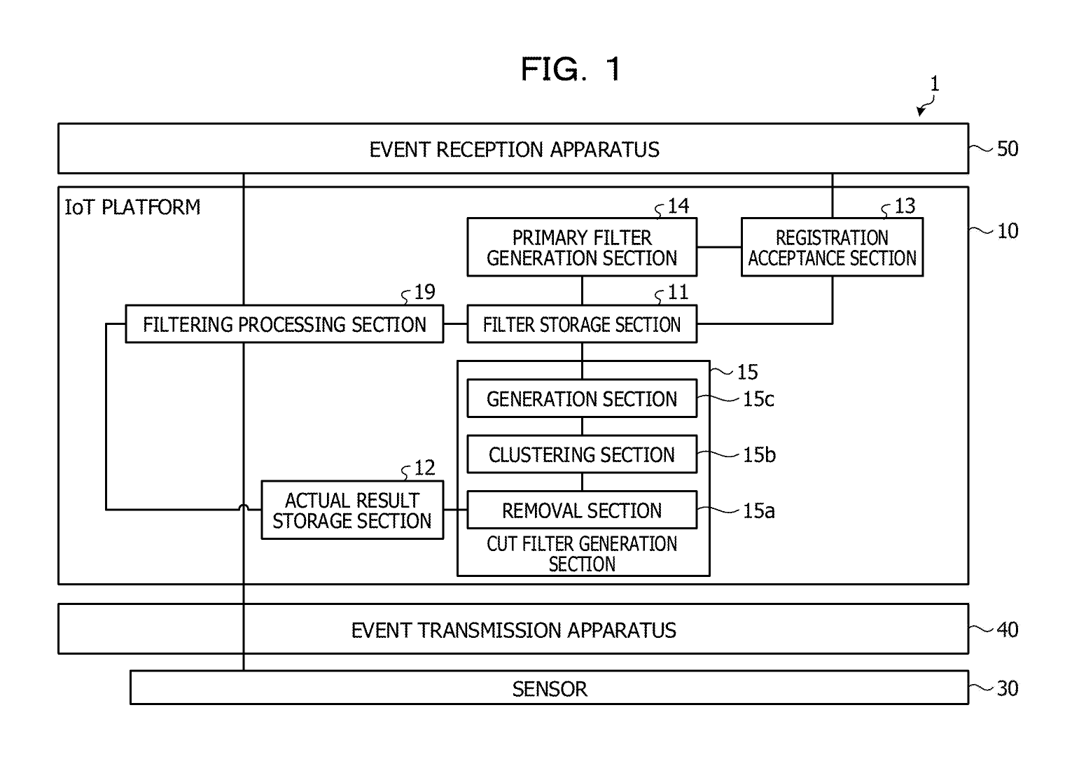

FIG. 1 depicts an example of a functional configuration of each apparatus included in an Internet of things (IoT) system. An IoT system 1 depicted in FIG. 1 provides an IoT service that collects events from a sensor 30. As part of such an IoT service as just described, the IoT system 1 issues a notification of sensor data of events collected from the sensor 30, for example, big data, to a service or an application that implements various solutions at the backend of an IoT platform 10, artificial intelligence (AI), an external computer or the like. It is to be noted that the IoT system 1 is an example of an information processing system.

In FIG. 1, a case in which a message foundation of the Pub/Sub type such as message queuing telemetry transport (MQTT) is utilized is exemplified as an example to the last. As depicted in FIG. 1, the IoT system 1 includes the IoT platform 10, an event transmission apparatus 40 and an event reception apparatus 50. It is to be noted that, while FIG. 1 exemplifies an example in which one event transmission apparatus 40 and one event reception apparatus 50 are accommodated in the IoT platform 10, a plurality of event transmission apparatus 40 and a plurality of event reception apparatus 50 may be accommodated in one IoT platform 10.

The IoT platform 10 is a computer that provides the IoT service described above. As one embodiment, the IoT platform 10 may be incorporated as a cloud that provides a function corresponding to the IoT service described above. Further, the IoT platform 10 may be incorporated as a Web server that provides the IoT service described above. It is to be noted that the IoT platform 10 is an example of an information processing apparatus.

In the example of a messaging model of the Pub/Sub type depicted in FIG. 1, the IoT platform 10 corresponds to the Broker. For example, in the case where the IoT platform 10 accepts an MQTT message of an event transmitted from the event transmission apparatus 40, it transfers the event to the event reception apparatus 50 in accordance with a topic designated by the MQTT message. In the case where the event is transferred to the event reception apparatus 50 in this manner, the IoT platform 10 transfers the MQTT message to the event reception apparatus 50 to which subscription to a topic is set already by a Subscribe command. Although a case in which a message foundation of the Pub/Sub type is utilized is exemplified as an example, mediation of an event may not necessarily be executed, and an event may be accumulated into a storage.

The event transmission apparatus 40 is a device that transmits an event of a sensor value outputted from the sensor 30 to the IoT platform 10. For example, the event transmission apparatus 40 corresponds to an IoT device in which an MQTT client of the Publisher operates. As an example of such an IoT device as just described, a portable terminal apparatus such as a slate terminal or a tablet terminal, a gadget such as a ring or a bracelet, a wearable device such as smart glasses and so forth correspond in addition to smartphones, mobile phones, personal handyphone systems (PHS), and so forth. Such an IoT device as just described has an arbitrary sensor 30 built therein or attached thereto. For example, the sensor 30 may be a temperature sensor or a humidity sensor, a motion sensor for an acceleration, a gyro or the like, a global positioning system (GPS) receiver for measuring position information or the like.

The event reception apparatus 50 is an apparatus that receives an event from the IoT platform 10. For example, the event reception apparatus 50 corresponds to a module that has an environment in which an MQTT client of the Subscriber operates and in which subscription of a topic allocated to the event transmission apparatus 40 is set. As an example of this module, a service or an application that implements various solutions at the backend of the IoT platform 10, AI, an arbitrary computer outside a data center or the like corresponds.

As part of such an IoT service, the IoT platform 10 executes a filtering process for events collected from the sensor 30 in accordance with a pass filter in which a region of interest of a sensor value is set by the Subscriber.

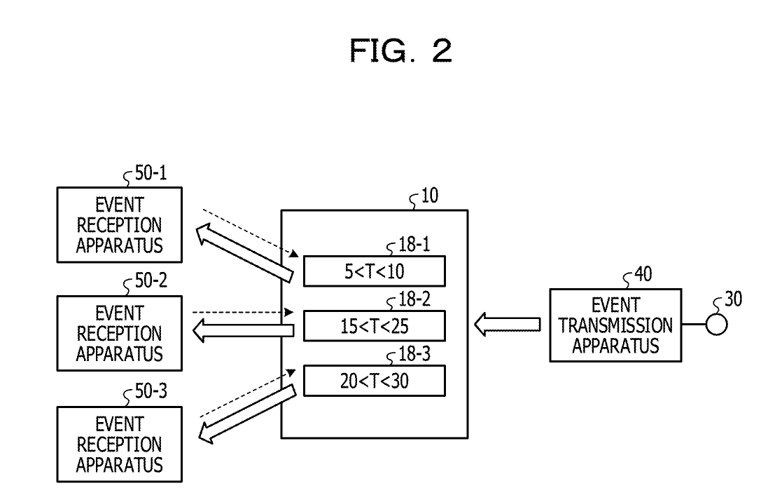

FIG. 2 depicts an example of a filtering process. In FIG. 2, as an example of the sensor 30, an example is depicted in which an event of a temperature T (° C.) outputted from a temperature sensor is published by the event transmission apparatus 40. Further, in FIG. 2, an example is depicted in which subscription of a topic allocated to the event transmission apparatus 40 is set by event reception apparatus 50-1 to 50-3.

As depicted in FIG. 2, in the IoT platform 10, three pass filters 18-1, 18-2 and 18-3 are set. Of the pass filters, the pass filter 18-1 has registered therein a range of 5<T<10 as a region of interest by the event reception apparatus 50-1. Meanwhile, in the pass filter 18-2, another range of 15<T<25 is registered as a region of interest by the event reception apparatus 50-2. In the pass filter 18-3, a further range of 20<T<30 is registered as a region of interest by the event reception apparatus 50-3.

Under the situation in which the three pass filters 18-1 to 18-3 are set, in the case where an event of a measurement value of a temperature is transmitted as an MQTT message from the event transmission apparatus 40 to the IoT platform 10, such a filtering process as described below is executed.

For example, the IoT platform 10 filters an event transmitted from the event transmission apparatus 40 using the pass filter 18-1. For example, The IoT platform 10 decides whether or not the measurement value of the temperature belongs to the region of interest “5<T<10” defined in the pass filter 18-1, for example, whether or not the measurement value of the temperature is higher than 5° C. but is lower than 10° C. As a result, in the case where the measurement value of the temperature belongs to the region of interest “5<T<10,” the IoT platform 10 extracts the event as an event to be published to the event reception apparatus 50-1. On the other hand, in the case where the measurement value of the temperature does not belong to the region of interest “5<T<10,” the IoT platform 10 excludes the event from an event to be published to the event reception apparatus 50-1.

The IoT platform 10 filters an event transmitted from the event transmission apparatus 40 using the pass filter 18-2. For example, the IoT platform 10 decides whether or not the measurement value of the temperature belongs to the region of interest “15<T<25” defined in the pass filter 18-2, for example, whether or not the measurement value of the temperature is higher than 15° C. but is lower than 25° C. As a result, in the case where the measurement value of the temperature belongs to the region of interest “15<T<25,” the IoT platform 10 extracts the event as an event to be published to the event reception apparatus 50-2. On the other hand, in the case where the measurement value of the temperature does not belong to the region of interest “15<T<25,” the IoT platform 10 excludes the event from an event to be published to the event reception apparatus 50-2.

Further, the IoT platform 10 filters an event transmitted from the event transmission apparatus 40 using the pass filter 18-3. For example, the IoT platform 10 decides whether or not the measurement value of the temperature belongs to the region of interest “20<T<30” defined in the pass filter 18-3, for example, whether or not the measurement value of the temperature is higher than 20° C. and but is lower than 30° C. As a result, in the case where the measurement value of the temperature belongs to the region of interest “20<T<30,” the IoT platform 10 extracts the event as an event to be published to the event reception apparatus 50-3. On the other hand, in the case where the measurement value of the temperature does not belong to the region of interest “20<T<30,” the IoT platform 10 excludes the event from an event to be published to the event reception apparatus 50-3.

In the case where a filtering process for an event transmitted from the event transmission apparatus 40 is performed using the pass filters in this manner, as the number of pass filters increases, the number of times by which filtering is executed increases. For example, in the case where the number of filters set to the Broker is ten and the Publisher transmits an event every second, filtering is executed by totaling 600 times for one minutes. This sometimes causes exhaustion of a hardware resource of the Broker such as a processor or a memory and degrades the throughput of data processed by the Broker, and as a result, an event may not be transferred rapidly to the Subscriber.

From this, in order to reduce the load of the filtering process, before filtering in which a pass filter is used, filtering is sometimes executed using a primary filter generated by clustering the pass filters.

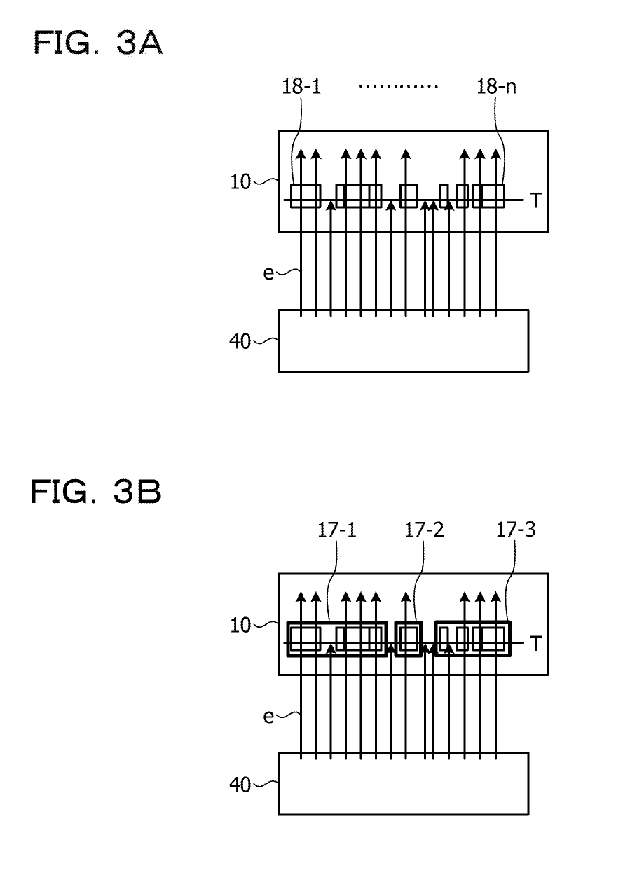

A case in which filtering is executed using pass filters and another case in which filtering is executed using a primary filter at a preceding stage to the pass filters are compared with each other with reference to FIGS. 3A and 3B.

FIGS. 3A and 3B depict an example of a filtering process. As depicted in FIGS. 3A and 3B, pass filters 18-1 to 18-n in which a region of interest of a sensor value is registered for each event reception apparatus 50-1 to 50-n that subscribes a topic allocated to the event transmission apparatus 40 are set in the IoT platform 10. Further, in FIGS. 3A and 3B, an evaluation axis indicative of whether the temperature is high or low in a block of the IoT platform 10 is indicated in the leftward and rightward direction. The evaluation axis for the temperature signifies that, as an example, the temperature indicates decrease in the leftward direction and indicates increase in the rightward direction. Furthermore, on the evaluation axis of the temperature depicted in FIGS. 3A and 3B, blocks corresponding to numerical value ranges registered as regions of interest for each of the pass filters 18-1 to 18-n are plotted schematically. It is to be noted that, in the following description, in the case where the pass filters 18-1 to 18-n are collectively referred to without identifying them individually, they are referred to each as “pass filter 18.” Further, in the case where the primary filters 17-1 to 17-3 are collectively referred to without identifying them individually, they are referred to each as “primary filter 17.”

FIG. 3A depicts an example in which filtering is executed using the pass filters 18-1 to 18-n. In this case, as depicted in FIG. 3A, filtering is executed for each of the pass filters 18-1 to 18-n whatever value is taken by the sensor value of an event e transmitted from the event transmission apparatus 40. As a result, it may be recognized that filtering is executed by n times for each one event.

On the other hand, FIG. 3B depicts a case in which filtering is executed using the primary filters 17-1 to 17-3 at the preceding state to the pass filters 18-1 to 18-n. As depicted in FIG. 3B, regions of interest overlapping with or positioned closely to each other among the pass filters 18-1 to 18-n are aggregated down to the three primary filters 17-1 to 17-3 by clustering. Here, attention is paid to a case in which the sensor value of the event e transmitted from the event transmission apparatus 40 does not belong to any one of the regions of interest of the primary filters 17-1 to 17-3. In this case, at the stage when filtering is executed by three times for the primary filters 17-1 to 17-3, it may be identified that the sensor value of the event e does not belong to any one of the regions of interest of the pass filters 18-1 to 18-n. Therefore, since filtering using the pass filters 18-1 to 18-n may be omitted, the number of times of filtering of the Broker may be reduced.

However, only if filtering is executed using a primary filter, the number of times of filtering to be executed by the IoT platform 10 that is the Broker may not necessarily be reduced.

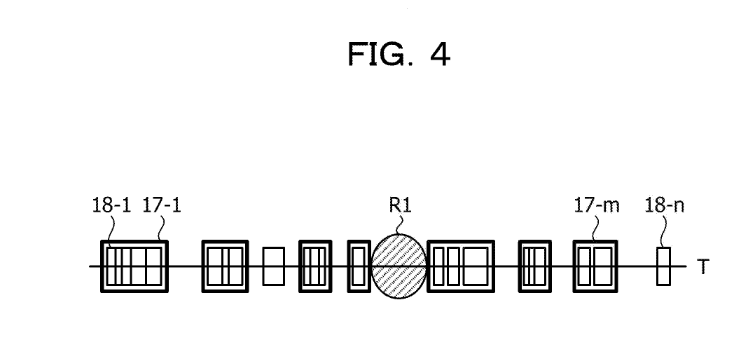

FIG. 4 depicts an example of a region of interest. In FIG. 4, an evaluation axis for the temperature is indicated in the leftward and rightward direction, and as an example, the temperature indicates decrease in the leftward direction and indicates increase in the rightward direction. Further, on the evaluation axis for the temperature depicted in FIG. 4, blocks corresponding to numerical value ranges registered as regions of interest are modeled with thin lines for the individual pass filters 18-1 to 18-n, and blocks corresponding to numerical value ranges registered as regions of interest are modeled with thick lines for the individual primary filters 17-1 to 17-m.

Although, as described in the background above, a region of interest of a pass filter is set through the Subscribe command for each Subscriber who subscribes a same topic, a region of interest does not necessarily overlap or is positioned closely between different pass filters. In the case where the regions of interest of pass filters disperse, a difference is less likely to occur between the number of clusters into which the regions of interest of pass filters are clustered, for example, the number of primary filters, and the number of pass filters.

Although, in the example depicted in FIG. 4, regions of interest that overlap with or are positioned closely to each other among the pass filters 18-1 to 18-n are clustered, only it is possible to aggregate them into m clusters of the primary filters 17-1 to 17-m. In the case where regions of interest of pass filters disperse in this manner, the aggregation effect of regions of interest of pass filters is low and a difference in number is less likely to occur between the pass filters and primary filters. If, in such a situation as just described, sensor values of events e to be published from the event transmission apparatus 40 to the IoT platform 10 are concentrated in a region R1 that is outside the regions of interest of the primary filters 17-1 to 17-m, filtering is executed for each m primary filters 17-1 to 17-m having no great difference from the number n of the pass filters 18-1 to 18-n. In this case, since the number of times of execution of filtering does not vary from that in the case where filtering is executed for each pass filter, the number of times of filtering in the Broker may not decrease.

In the IoT system 1, a cut filter for removing events whose sensor value belongs to a region in which events are distributed in a concentrated manner within a region outside the regions of interest of the pass filters is used for filtering at a preceding stage to the pass filters.

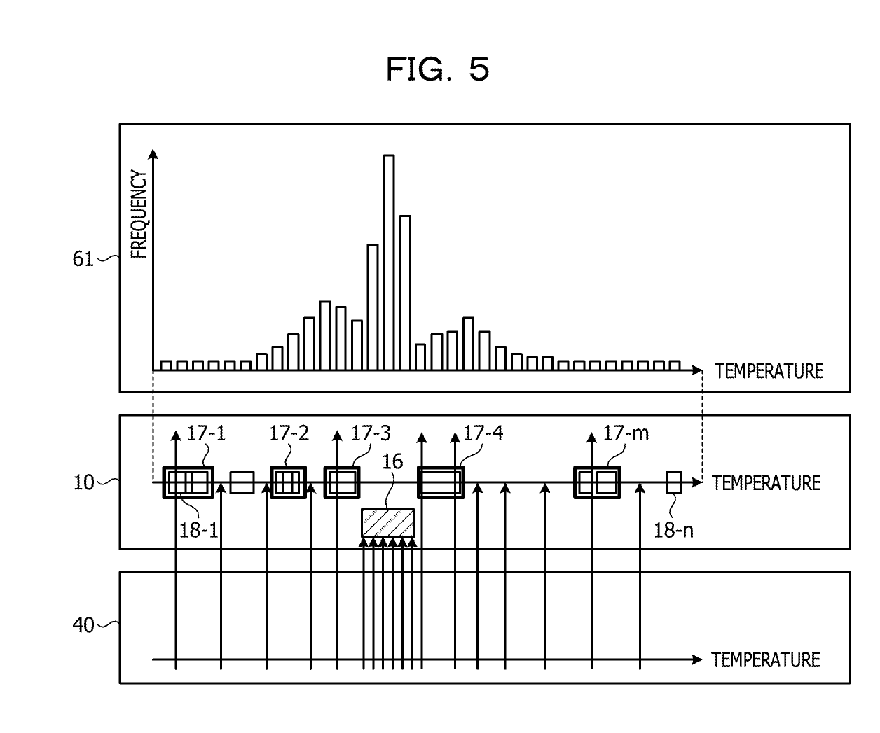

FIG. 5 depicts an example of a cut filter. Also in FIG. 5, an evaluation axis for the temperature is indicated in the leftward and rightward direction. As an example, the evaluation axis for the temperature signifies that, as an example, the temperature indicates decrease in the leftward direction and indicates increase in the rightward direction. Furthermore, on the evaluation axis for the temperature depicted in FIG. 5, blocks corresponding to numerical value ranges registered as regions of interest are modeled with thin lines for the individual pass filters 18-1 to 18-n, and blocks corresponding to numerical value ranges registered as regions of interest are modeled with thick lines for the individual primary filters 17-1 to 17-m. Furthermore, FIG. 5 depicts a histogram 61 that has the evaluation axis for the temperature described above as an abscissa and has the frequency, by which an event in which, for each class of the temperature, a temperature of the class is measured as a sensor value occurs, as an ordinate.

In the histogram 61 depicted in FIG. 5, it may be recognized that sensor values of events e to be published from the event transmission apparatus 40 to the IoT platform 10 are concentrated in a region that is outside the regions of interest of the pass filters 18-1 to 18-n or a region that is outside the regions of interest of the primary filters 17-1 to 17-m. A cut filter 16 is generated which excludes events e whose sensor value belongs to a region within which the occurrence frequency of events e is distributed in a concentrated manner in a range outside the regions of interest of the pass filters 18-1 to 18-n in this manner.

Filtering that uses such a cut filter 16 as just described is executed prior to filtering that uses the pass filters 18-1 to 18-n and the primary filters 17-1 to 17-m. Consequently, even in the case where events e whose sensor value belongs to a range outside the regions of interest of the pass filters 18-1 to 18-n are concentrated, only by executing filtering using the cut filter 16 once, filterout of the pass filters 18-1 to 18-n and the primary filters 17-1 to 17-m may be identified.

Accordingly, with the IoT system 1, the load of the filtering process may be reduced.

As depicted in FIG. 1, the IoT platform 10 includes a filter storage section 11, an actual result storage section 12, a registration acceptance section 13, a primary filter generation section 14, a cut filter generation section 15 and a filtering processing section 19. It is to be noted that the IoT platform 10 may include, in addition to the functional sections depicted in FIG. 1, various functional sections a known computer includes, for example, an inputting section, an outputting section and so forth.

Such functional sections as the registration acceptance section 13, primary filter generation section 14, cut filter generation section 15 and filtering processing section 19 depicted in FIG. 1 are virtually implemented by a hardware processor such as a central processing unit (CPU) or a micro processing unit (MPU). For example, the functional sections described above are virtually implemented by deploying, by a processor, an information processing program for implementing the IoT service described above as a process into a memory such as a random access memory (RAM). While a CPU or an MPU is exemplified as an example of a processor, the functional sections described above may be implemented by an arbitrary processor irrespective of whether the processor is of the general purpose type or of the specialized type. Further, the functional sections described above may be implemented by hard wired logic such as an application specific integrated circuit (ASIC) or a field programmable gate array (FPGA).

For the functional sections such as the filter storage section 11 and the actual result storage section 12 depicted in FIG. 1, such a storage apparatus as a hard disk drive (HDD), an optical disk, or a solid state drive (SSD) may be adopted. It is to be noted that the storage apparatus may not necessarily be an auxiliary storage apparatus, but also various semiconductor memory elements, for example, a RAM, an electrically erasable programmable read-only memory (EEPROM), a flash memory may or the like be adopted.

Various filters are stored into the filter storage section 11. For example, into the filter storage section 11, for each topic allocated to the event transmission apparatus 40, not only pass filters to be registered by the event reception apparatus 50 but also primary filters to be generated by the primary filter generation section 14, cut filters to be generated by the cut filter generation section 15 and so forth are stored in association with each other.

In the actual result storage section 12, actual results of the frequency by which an event occurs are stored. For example, every time the actual result storage section 12 accepts an MQTT message of an event transmitted from the event transmission apparatus 40, contents of the event, for example, sensor values or the like are registered in an associated relationship with a topic designated by the MQTT message into the actual result storage section 12 by the filtering processing section 19 hereinafter described.

The registration acceptance section 13 is a processing section that accepts registration of a pass filter. As one embodiment, the registration acceptance section 13 accepts a registration request for a pass filter from the event reception apparatus 50. The registration request includes, as an example, a topic, a pass filter and so forth that are made an application target of a pass filter from among topics that are being subscribed by the event reception apparatus 50. Then, the registration acceptance section 13 registers the pass filter in an associated relationship with the topic into the filter storage section 11 in accordance with the registration request. It is to be noted here that, while, as an example, registration of a pass filter is described, also it is possible to change the region of interest of the pass filter or to delete a pass filter being registered in the filter storage section 11.

The primary filter generation section 14 is a processing section that generates a primary filter. It is to be noted here that, although an example in which filtering is executed using a primary filter by the IoT platform 10 that is the Broker is described as an example to the last, generation of a primary filter and filtering that uses the primary filter may not necessarily be executed.

For example, in the case where a novel pass filter is registered into the filter storage section 11 or setting of a region of interest of a pass filter registered already is changed, the primary filter generation section 14 starts generation of a primary filter relating to the topic for which the registration of the novel pass filter or the setting change of the region of interest is performed. For example, the primary filter generation section 14 reads out pass filters relating to the topic for which registration of the novel pass filter or setting change of the region of interest has been performed from among the pass filters stored in the filter storage section 11. Then, the primary filter generation section 14 clusters the pass filters read out from the filter storage section 11. Consequently, regions of interest overlapping with or positioned closely to each other between the pass filters are aggregated into a cluster. Then, the primary filter generation section 14 registers a primary filter having a region of interest corresponding to the shape of the cluster in an associated with the topic. It is to be noted that, while a case in which a primary filter is updated in the case where new registration of a pass filter or setting change of a region of interest is performed is exemplified here, in the case where the shape of each cluster is not different very much before and after updating, the updating may not necessarily be executed.

The cut filter generation section 15 is a processing section that generates a cut filter. Here, timings at which generation of a cut filter is started include, as an example, a phase of generating a new cut filter and another phase of updating the cut filter.

For example, in the former phase, in a case where events transmitted from the event transmission apparatus 40 are accumulated into the actual result storage section 12 for a given period of time, for example, for one week, in another case in which a given number of events are accumulated into the actual result storage section 12 or in a like case, generation of a new cut filter may be started. In addition, it is also possible to start generation of a new cut filter when a condition is satisfied that a number of events in a cluster having the greatest number of events from among clusters, which are obtained by clustering the events stored in the actual result storage section 12, reach a prescribed value.

In the latter phase, updating of a cut filter may be carried out, in addition to a case in which registration of a pass filter is accepted from the event reception apparatus 50 that newly performs subscription of a topic, in a case in which a great variation occurs in the distribution of sensor values outputted from the sensor 30 or in a like case. For example, as an example of a detection method of a variation of the distribution, a method for comparing differences in shape of clusters in two distributions with each other is available. For example, clustering is executed for each of a distribution of events used for generation or updating of a cut filter being applied to the filtering process from among the events accumulated in the actual result storage section 12 and a distribution of events accumulated in the actual result storage section 12 after updated into a cut filter being applied to the filtering process. Then, in the case where the difference in shape between the clusters in which the number of events included herein is in the maximum is equal to or greater than a prescribed value, updating of the cut filter may be carried out. In the case where such comparison is performed, as an example, comparison is performed after the differences in total number of events between the two distributions are made equal to or made included in a given value.

As depicted in FIG. 1, the cut filter generation section 15 includes a removal section 15a, a clustering section 15b and a generation section 15c.

The removal section 15a is a processing section that excludes, from among event achievements stored in the actual result storage section 12, events whose sensor value belongs to a region of interest of the pass filter to be used in filtering.

For example, a case in which the dimension of sensor values of events for which filtering is to be carried out is n (natural number) is taken as an example. First, the removal section 15a reads out events stored in the actual result storage section 12. For example, in the case where a new cut filter is to be generated, the removal section 15a not only may read out the events accumulated in the actual result storage section 12 over a given period of time but also may read out events whose number reaches a given number from the actual result storage section 12. Further, when updating of a cut filter is to be performed, the removal section 15a reads out events accumulated in the actual result storage section 12 after updated to the cut filter being currently applied in the filtering process. After the events are read out in this manner, the removal section 15a trims (removes), from among the events distributed in the n-dimensional space, events that belong to the region of interest of the pass filter registered in the filter storage section 11 in an associated relationship with a topic that is a generation target of the cut filter. It is to be noted that, while a case in which events belonging to the region of interest of the pass filter are removed is exemplified here, events belonging to a region of interest of a primary filter in place of the pass filter may be removed.

The clustering section 15b is a processing section that clusters a distribution of events remaining without being removed by the removal section 15a.

For example, the clustering section 15b clusters, in the n-dimensional space, the distribution of the events remaining when the events belonging to the region of interest of the pass filter are removed by the removal section 15a from the events read out from the actual result storage section 12. To the clustering executed here, as an example, an arbitrary technique such as the K-Means method or the like may be applied. Further, for each of the clusters obtained by the clustering, the clustering section 15b counts the number of events included in the cluster. The score counted in this manner is used as a cluster score.

The generation section 15c is a processing section that generates a cut filter based on a cluster obtained by clustering.

For example, the generation section 15c extracts, from among the clusters obtained by clustering by the clustering section 15b, a cluster or clusters whose cluster score satisfies a given condition. For example, the generation section 15c may extract a given number of clusters in the descending order of the cluster score or may extract clusters whose cluster score is equal to or higher than a given threshold value. Then, the generation section 15c approximates, for each of the clusters extracted in accordance with the condition described above, the shape of the cluster to a given model. Then, the generation section 15c registers a cut filter including a region of interest corresponding to the shape of the model in an associated relationship with the topic into the filter storage section 11. It is to be noted that, while a case in which the shape of a cluster here is approximated to a model is exemplified as an example to the last, it is a matter of course that the shape itself of the cluster may be made a region of interest of the cut filter.

The filtering processing section 19 is a processing section that executes a filtering process using a filter stored in the filter storage section 11.

For example, every time the filtering processing section 19 accepts an MQTT message of an event transmitted from the event transmission apparatus 40, it executes a filtering process in the priority order of a cut filter, a primary filter and a pass filter. It is to be noted that the filtering process of a filter having no registration in the filter storage section 11 is skipped.

For example, every time the filtering processing section 19 accepts an event from the event transmission apparatus 40, it executes such a process as described below. For example, in the case where a cut filter is registered in the filter storage section 11 in an associated relationship with a topic designated by the MQTT message of the event, the filtering processing section 19 executes filtering using the cut filter by deciding, for each cut filter, whether or not the sensor value of the event belongs to the region of interest of the cut filter. Here, in the case where the sensor value of the event belongs to the region of interest of some cut filter, filterout of the pass filter 18 and the primary filter 17 may be identified. In this case, transfer of the event to the event reception apparatus 50 that is the Subscriber is not executed.

On the other hand, in the case where the sensor value of the event does not belong to the region of interest of any cut filter, the filtering processing section 19 decides whether or not a registration of a primary filter exists in the filter storage section 11. At this time, in the case where a registration of a primary filter exists, the filtering processing section 19 executes filtering using the primary filter by deciding, for each primary filter, whether or not the sensor value of the event belongs to the region of interest of the primary filter. It is to be noted that, in the case where a registration of a primary filter does not exist, the filtering in which the primary filter is used is skipped, and filtering in which a pass filter is used is executed.

At this time, in the case where the sensor value of the event belongs to the region of interest of any primary filter, filterout of pass filters other than the pass filters included in the cluster of the primary filter may be identified. In this case, the filtering processing section 19 executes filtering using the pass filter by deciding, for each of the pass filters included in the cluster of the primary filter, whether or not the sensor value of the event belongs to the region of interest of the pass filter. Thereafter, the filtering processing section 19 distributes the event whose sensor value belongs to the region of interest of the pass filter to the event reception apparatus 50 by which registration of the pass filter has been performed.

In the case where the sensor value of the event does not belong to the region of interest of any primary filter, the filtering processing section 19 and executes filtering using the pass filter by deciding, for each of the pass filters that are not included in the cluster of the primary filter, whether or not the sensor value of the event belongs to the region of interest of the pass filter. Thereafter, the filtering processing section 19 distributes the event whose sensor value belongs to the region of interest of the pass filter to the event reception apparatus 50 by which registration of the pass filter has been performed.

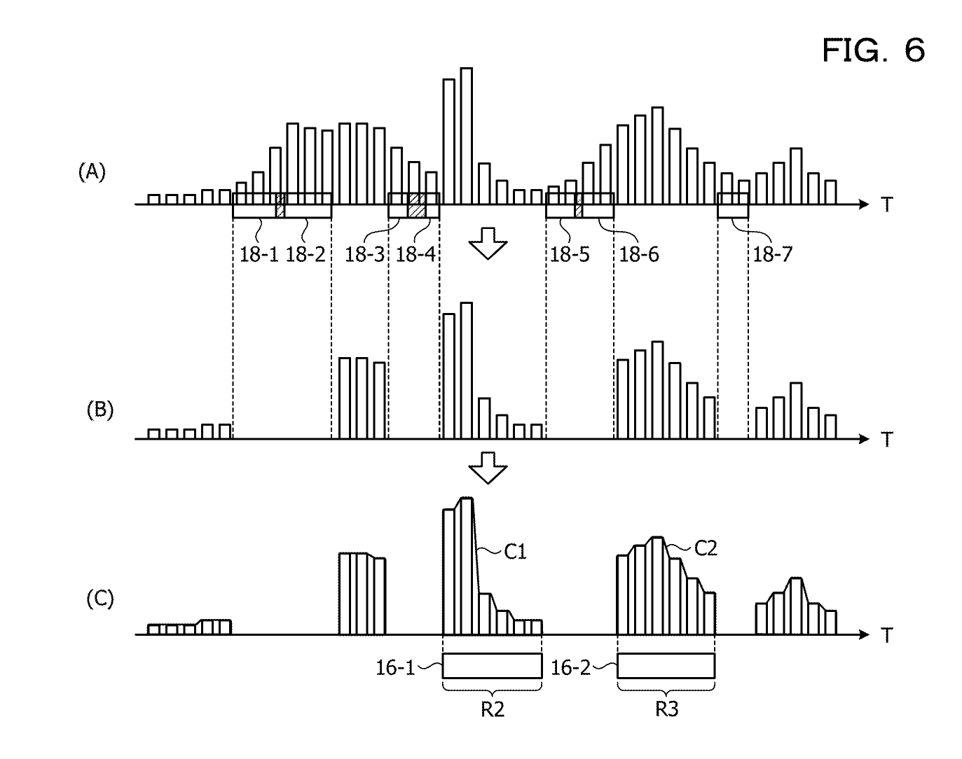

FIG. 6 depicts an example of a histogram. As depicted in (A) of FIG. 6, the removal section 15a generates a histogram by counting, for each of events accumulated in the actual result storage section 12 over a given period of time, the frequency of a class to which the sensor value of the event, in the present embodiment, the measurement value of the temperature belongs. Here, the ordinate of the graph depicted in (A) of FIG. 6 indicates the frequency, and the abscissa indicates the class of a sensor value. Further, in (A) of FIG. 6, blocks corresponding to numerical value ranges registered as regions of interest for each of the pass filters 18-1 to 18-7 are modeled on the abscissa of the graph, and a region in which regions of interest overlap with each other between pass filters 18 is indicated by slanting lines.

From the histogram generated in this manner, the removal section 15a trims any event having a class value in the regions of interest of the pass filters 18-1 to 18-7 or in a class overlapping with the regions of interest corresponding to the clusters of the pass filters 18. As a result, the histogram depicted in (A) of FIG. 6 is worked to that depicted in (B) of FIG. 6.

Then, the clustering section 15b identifies fragments of the histogram depicted in (B) of FIG. 6 as clusters. Then, the generation section 15c calculates, for each cluster, the area of the cluster. Then, the generation section 15c selects, from among the clusters, a top given number of clusters having great areas. Here, as an example, a case in which clusters that are top two in ranking of the area are selected is exemplified. In this case, a cluster C1 and another cluster C2 are selected as depicted in (C) of FIG. 6. Then, the generation section 15c generates a cut filter 16-1 having a domain R2 of classes included in the cluster C1 in the region of interest and another cut filter 16-2 having another domain R3 of classes included in the cluster C2 in the region of interest. The cut filters 16 generated in this manner are registered into the filter storage section 11.

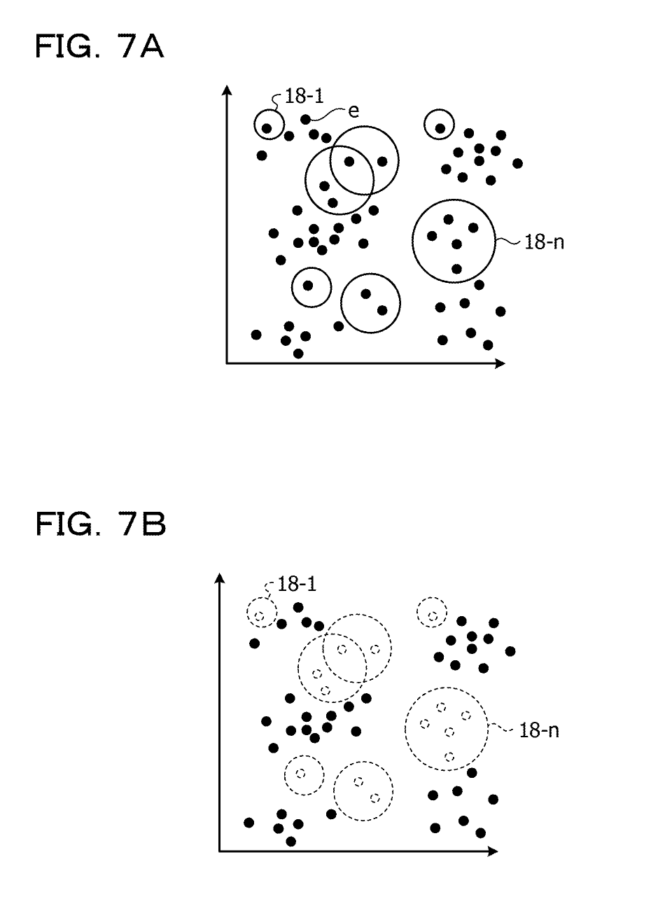

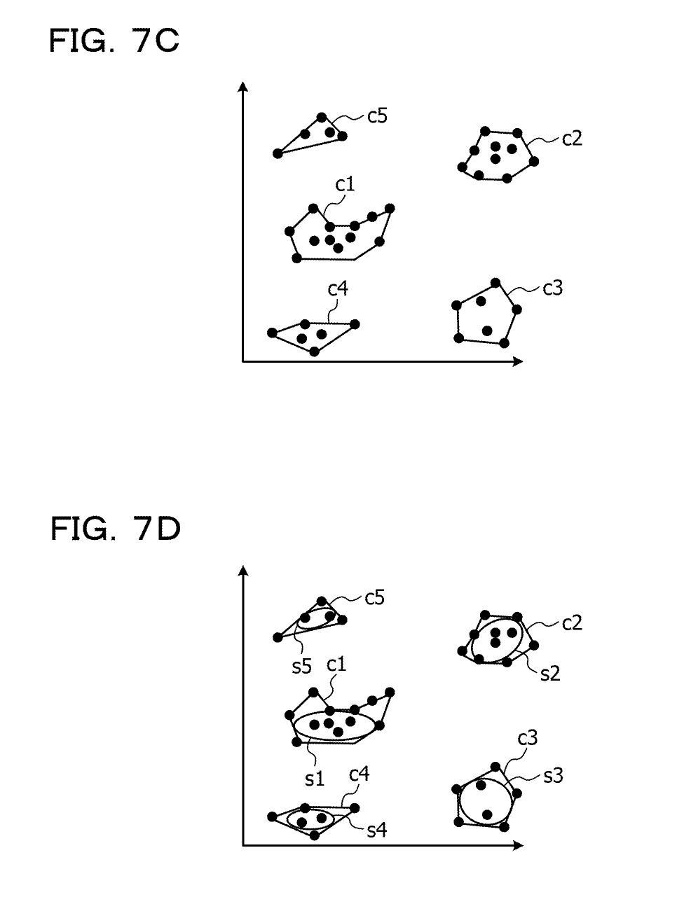

FIGS. 7A to 7D depict an example of a two-dimensional scatter diagram of events. The ordinate of the scatter diagram depicted in FIGS. 7A to 7D indicates the physical quantity corresponding to one of two sensor values included in the event e, and the ordinate indicates the physical quantity corresponding to the other sensor value. The physical quantities may be different physical quantities from each other like the temperature and the humidity or may be physical quantities of the same type like accelerations of a multi-axis acceleration sensor.

First, the removal section 15a plots, for each of events accumulated in the actual result storage section 12 over a given period of time, sensor values of the event in a two-dimensional space to generate the scatter diagram depicted in FIG. 7A. In FIG. 7A, boundaries between the regions of interest of the pass filters 18-1 to 18-n are indicated by solid lines for the convenience of illustration. The removal section 15a trims events included in the regions of interest of the pass filters 18-1 to 18-n from among the events plotted in the two-dimensional space. As a result, the scatter diagram depicted in FIG. 7A changes to the scatter diagram depicted in FIG. 7B.

Then, the clustering section 15b clusters the distribution of the events of the scatter diagram depicted in FIG. 7B by applying the K-means method or the like. Then, the generation section 15c detects a convex hull of each of the clusters obtained by the clustering. As a result, convex hulls c1 to c5 of the clusters depicted in FIG. 7C are detected. Thereafter, the generation section 15c calculates, for each cluster, the convex hull of the cluster, for example, an ellipse that inscribes the convex hull, for example, a maximum inscribed ellipse, by a least-square method or the like. As a result, maximum inscribed ellipses s1 to s5 of the convex hulls are calculated as depicted in FIG. 7D.

Then, the generation section 15c selects a top given number of clusters having great plot numbers of events included in an ellipse from among the maximum inscribed ellipses s1 to s5. Here, as an example, a case in which clusters that are top two in ranking of the plot number are selected is exemplified. In this case, the maximum inscribed ellipse s1 of the convex hall c1 and the maximum inscribed ellipse s2 of the convex hall c2 are selected as depicted in FIG. 7D. Thereafter, the generation section 15c generates a cut filter 16-1 having the maximum inscribed ellipse s1 in the region of interest and a cut filter 16-2 having the maximum inscribed ellipse s2 in the region of interest. The cut filters 16 generated in this manner are registered into the filter storage section 11.

Here, the reason why a convex hull of a cluster is approximated to a maximum inscribed ellipse is that, in order to execute inside/outside decision of a region of interest of a cut filter, the ellipse is more advantageous than the convex hull in terms of the processing amount and the processing speed. Naturally, it is a matter of course that the convex hull may be made the region of interest of a cut filter.

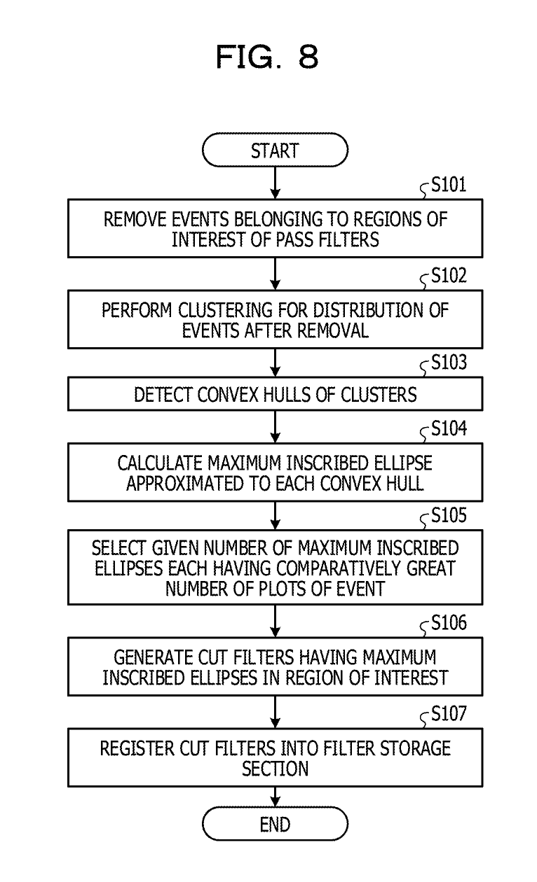

FIG. 8 depicts an example of a generation process of a cut filter. The generation process of a cut filter is started in the case where, as an example, the condition for generating a new cut filter or the condition for updating the cut filter is satisfied as described hereinabove. In FIG. 8, a procedure of the generation process of a cut filter in the case where the IoT platform 10 filters two-dimensional events e as an example to the last is depicted.

As depicted in FIG. 8, the removal section 15a removes events included in regions of interest of pass filters 18 from a scatter diagram of the events read out from the actual result storage section 12 (step S101).

Then, the clustering section 15b clusters the distribution of events remaining when the events included in the regions of interest of the pass filters are removed from the scatter diagram of events at step S101 by applying the K-means method or the like (step S102).

Then, the generation section 15c detects a convex hull of each of the clusters obtained at step S102 (step S103). Thereafter, the generation section 15c calculates, for each cluster, the convex hull of the cluster, for example, an ellipse that is approximated to a convex hull, for example, a maximum inscribed ellipse, by a least-square method or the like (step S104).

The generation section 15c selects a top given number of maximum inscribed ellipses having great plot numbers of events included in an ellipse from among the maximum inscribed ellipses s1 to s5 (step S105). Then, the generation section 15c generates, for each of the maximum inscribed ellipses selected at step S105, a cut filter 16 having the maximum inscribed ellipse in the region of interest (step S106). Finally, the generation section 15c registers the cut filters 16 generated at step S106 into the filter storage section 11 (step S107) and then ends the processing.

As described hereinabove, in the IoT system 1, a cut filter 16 that removes events whose sensor value belongs to a region in which events are distributed in a concentrated manner within a range outside the region of interest of the pass filter 18 is used for filtering at a stage preceding to the pass filters 18 or the primary filters 17. Consequently, even in the case where events e whose sensor values belong to the range outside the region of interest of the pass filters 18 are concentrated, filterout of the pass filters 18 and the primary filters 17 may be identified only by executing filtering using the cut filter 16 once. Accordingly, with the IoT system 1, the load of the filtering process may be reduced.

Although the foregoing description exemplifies a case in which a message foundation of the Pub/Sub type is used, mediation of events may not necessarily be executed, and events may be accumulated into a storage. Further, the filter generation process or the filtering process may be applied similarly in various fields in which it is preferable to perform a filtering process of received events at a high speed like a hit determination in a shooting game.

Although the foregoing description exemplifies a case in which a filtering process corresponding to each filter is executed by that IoT platform 10 that is the Broker, filtering processes corresponding to all kinds of filters may not necessarily be executed by the IoT platform 10. For example, in the case where the event transmission apparatus 40 has a performance in that the operation frequency, core number or cache of a processor incorporated therein is equal to or higher than a given threshold value, the filtering process in which the cut filter 16 or the primary filters 17 is used may be offloaded to the Publisher.

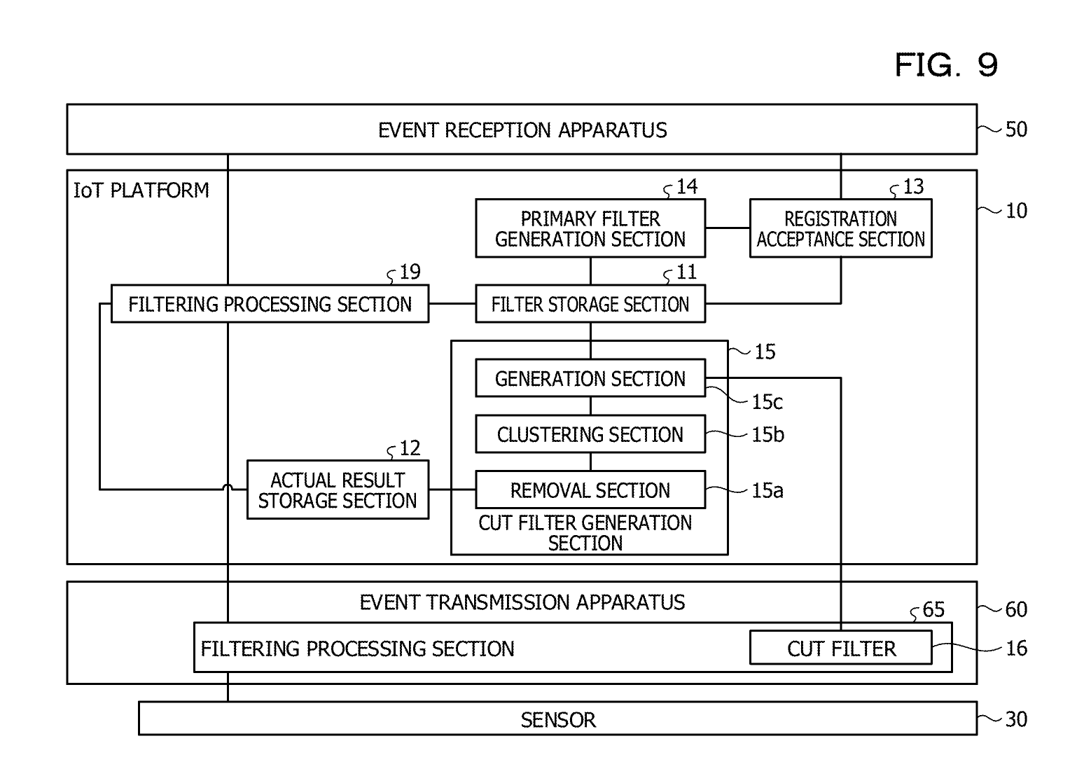

FIG. 9 depicts an example of a functional configuration of each apparatus included in a different IoT system. An event transmission apparatus 60 depicted in FIG. 9 is different from the event transmission apparatus 40 depicted in FIG. 1 in that it includes a filtering processing section 65.

Here, the filtering processing section 65 described above may be virtually implemented by executing, by a processor incorporated in the event transmission apparatus 60, a filtering program. The filtering processing section 65 executes the filtering process using, as an example, the cut filter 16 offloaded from the IoT platform 10. For example, the filtering processing section 65 decides, for each cut filter 16, whether or not a sensor value outputted from the sensor 30 belongs to the region of interest of the cut filter 16. At this time, in the case where the sensor value of the event belongs to the region of interest of one of the cut filters, filterout of the pass filters 18 and the primary filters 17 may be identified. In this case, since the publish to the Broker is not executed, the load of the filtering process on the Broker may be reduced. It is to be noted that, in the case where the sensor value of the event does not belong to the region of interest of any cut filter, the filtering processing section 65 publishes the event of the sensor value to the IoT platform 10 that is the Broker.

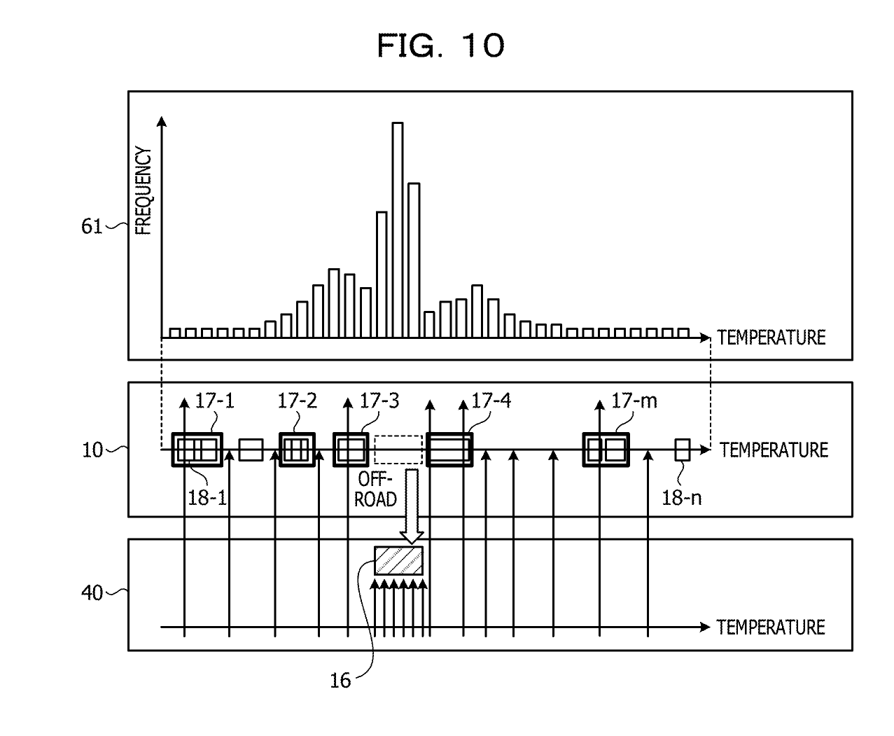

FIG. 10 depicts an example of a filtering process. In FIG. 10, an example is depicted in which the filtering process that uses the cut filter 16 from among the filtering processes in which the cut filter 16, primary filter 17 and pass filter 18 are used is offloaded to the event transmission apparatus 60 that is the Publisher. In the case where the filtering process that uses one cut filter 16 is offloaded to the event transmission apparatus 60 as depicted in FIG. 10, in the IoT platform 10 that is the Broker, the number of times of filtering may be reduced by once.

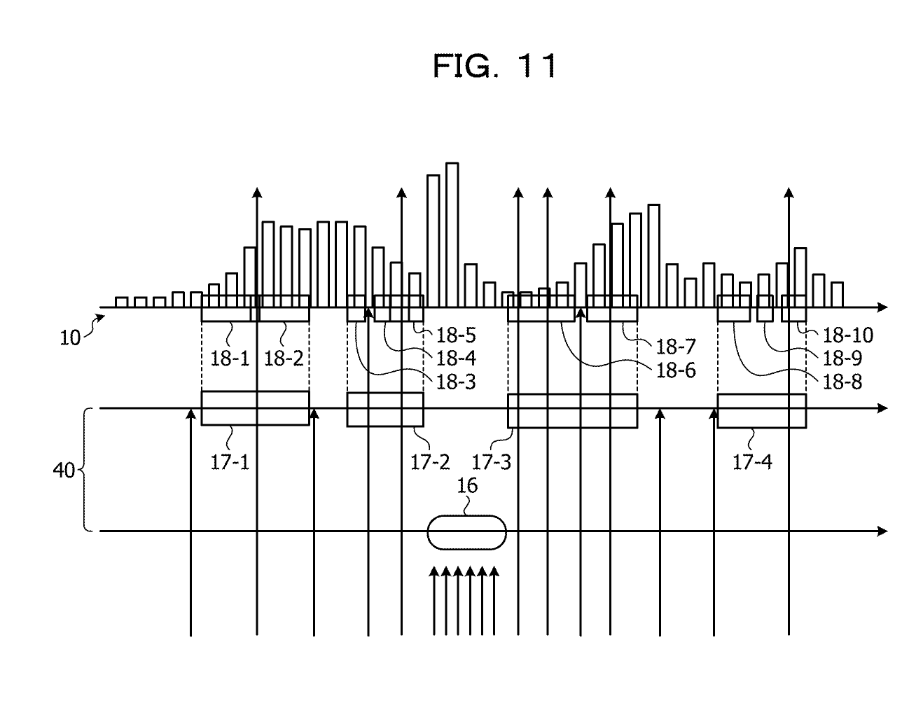

FIG. 11 depicts an example of a filtering process. In FIG. 11, an example is depicted in which the filtering processes that use the cut filter 16 and the primary filter 17 from among the filtering processes that use the cut filter 16, primary filter 17 and pass filter 18 are offloaded to the event transmission apparatus 60 that is the Publisher. As depicted in FIG. 11, in the case where the filtering process that uses one cut filter 16 and the filtering process that uses the four primary filters 17-1 to 17-4 are offloaded to the event transmission apparatus 60, in the IoT platform 10 that is the Broker, the number of times of filtering may be reduced by totaling five times.

The respective components of each apparatus depicted in the figures may not necessarily be configured physically in such a manner as depicted in the figures. For example, all or part of particular forms of disintegration and integration of each piece of apparatus may be functionally or physically disintegrated or integrated in an arbitrary unit in response to various loads, use situations and so forth in addition to those depicted in the figures. For example, the registration acceptance section 13, the primary filter generation section 14, the cut filter generation section 15 or the filtering processing section 19 may be coupled as an external apparatus of the IoT platform 10 through a network. Further, the registration acceptance section 13, the primary filter generation section 14, the cut filter generation section 15 and the filtering processing section 19 may individually be provided in different apparatus and coupled via network for cooperation with each other to implement the functions of the IoT platform 10 described hereinabove.

The various processes described above may be implemented by executing, by a computer such as a personal computer or a work station, a program prepared in advance.

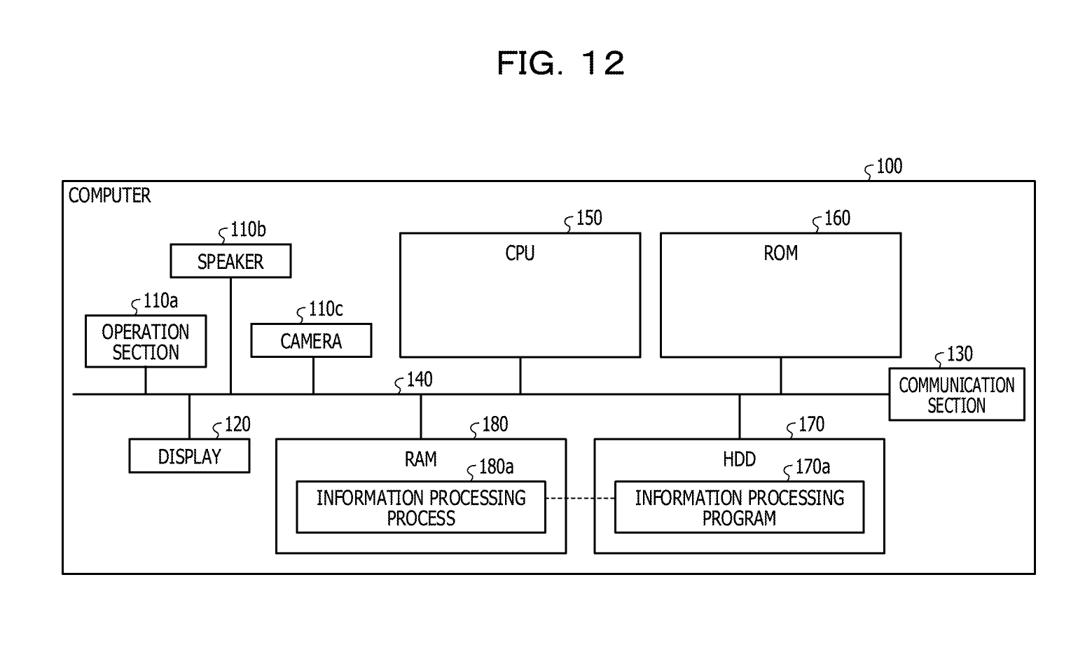

FIG. 12 depicts an example of a hardware configuration of a computer that executes an information processing program. As depicted in FIG. 12, the computer 100 includes an operation section 110a, a speaker 110b, a camera 110c, a display 120 and a communication section 130. Further, the computer 100 includes a CPU 150, a read only memory (ROM) 160, a HDD 170, and a RAM 180. The respective components 110 to 180 are coupled to each other through a bus 140.

In the HDD 170, an information processing program 170a that exhibits functions similar to those of the registration acceptance section 13, the primary filter generation section 14, the cut filter generation section 15 and the filtering processing section 19 described above is stored as depicted in FIG. 12. The information processing program 170a may be integrated or disintegrated similarly to the respective components including the registration acceptance section 13, the primary filter generation section 14, the cut filter generation section 15 and the filtering processing section 19 depicted in FIG. 1. For example, in the HDD 170, all data indicated in the embodiment 1 described hereinabove may not necessarily be stored, but data that are to be used in processing may be stored in the HDD 170.

Under such an environment as just described, the CPU 150 reads out the information processing program 170a from the HDD 170 and deploys the information processing program 170a into the RAM 180. As a result, the information processing program 170a functions as an information processing process 180a as depicted in FIG. 12. The information processing process 180a deploys various kinds of data read out from the HDD 170 into a region allocated to the information processing process 180a from within the storage region the RAM 180 includes, and executes various processes using the deployed various kinds of data. For example, as an example of the process executed by the information processing process 180a, the processes depicted in FIGS. 8 and 9 and the like are included. In the CPU 150, all of the processing sections indicated in the embodiment 1 described hereinabove may not necessarily operate, but a processing section corresponding to a process that is made an execution target may be implemented virtually.

The information processing program 170a described above may not necessarily be stored in the HDD 170 or the ROM 160 from the beginning. For example, the information processing program 170a is stored into a “portable physical medium” that is inserted, for example, into the computer 100 such as a flexible disk (FD), a compact disk-read only memory (CD-ROM), a digital versatile disk (DVD), a magneto-optical disk, or an integrated circuit (IC) card. The computer 100 may acquire the information processing program 170a from any of such portable physical media and execute the information processing program 170a. Alternatively, the information processing program 170a may be stored in a different computer, a server apparatus or the like coupled to the computer 100 through a public network, the Internet, a local area network (LAN), a wide area network (WAN) or the like in advance such that the computer 100 acquires information processing program 170a from any of them and execute the information processing program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and the processor configured to:
refer to actual result data of first events transmitted from a sensor;
remove, from the actual result data, second events in which a sensor value belongs to a region of interest of a pass filter used for filtering; and
generate, based on a number of third events in one or more clusters of distribution of the second events, a cut filter including a region of interest corresponding to a shape of the one or more clusters.

2. The information processing apparatus according to claim 1, wherein the processor is configured to:
generate the cut filter corresponding to the shape of each of the one or more clusters corresponding to a given number of clusters in the descending order of the number of third events.

3. The information processing apparatus according to claim 1, wherein the processor is configured to:
approximate the shape of the one or more clusters to a model having a given shape and generates the cut filter including a region of interest of a shape of the approximated model.

4. The information processing apparatus according to claim 1, wherein the processor is configured to:
execute a filtering process for the first events transmitted from the sensor using the cut filter and the pass filter.

5. The information processing apparatus according to claim 4, wherein the processor is configured to:
perform filtering for an event of a sensor value that is outside the region of interest of the cut filter in accordance with the region of interest of the pass filter.

6. The information processing apparatus according to claim 1, wherein the processor is configured to:
transmit the generated cut filter to the sensor or a communication apparatus in which the sensor is incorporated.

7. An information processing system, comprising:
an event transmission apparatus that transmits first events which is output from a sensor; and
an information processing apparatus that receives the first events from the event transmission apparatus and includes:
a memory; and
a processor coupled to the memory and the processor configured to:
refer to actual result data of first events transmitted from a sensor;
remove, from the actual result data, second events in which a sensor value belongs to a region of interest of a pass filter used for filtering; and
generate, based on a number of third events in one or more clusters of distribution of the second events, a cut filter including a region of interest corresponding to a shape of the one or more clusters.

8. The information processing system according to claim 7, wherein the processor is configured to:
generate the cut filter corresponding to the shape of each of the one or more clusters corresponding to a given number of clusters in the descending order of the number of third events.

9. The information processing system according to claim 7, wherein the processor is configured to:
approximate the shape of the one or more clusters to a model having a given shape and generates the cut filter including a region of interest of a shape of the approximated model.

10. The information processing system according to claim 7, wherein the processor is configured to:
execute a filtering process for the first events transmitted from the sensor using the cut filter and the pass filter.

11. The information processing system according to claim 10, wherein the processor is configured to:
perform filtering for an event of a sensor value that is outside the region of interest of the cut filter in accordance with the region of interest of the pass filter.

12. The information processing apparatus according to claim 7, wherein the processor is configured to:
transmit the generated cut filter to the event transmission apparatus.

13. An information processing method, comprising:
referring, by a computer, to actual result data of first events transmitted from a sensor;
removing, from the actual result data, second events in which a sensor value belongs to a region of interest of a pass filter used for filtering; and
generating, based on a number of third events in one or more clusters of distribution of the second events, a cut filter including a region of interest corresponding to a shape of the one or more clusters.

14. The information processing method according to claim 13, further comprising:
generating the cut filter corresponding to the shape of each of the one or more clusters corresponding to a given number of clusters in the descending order of the number of third events.

15. The information processing method according to claim 13, further comprising:
approximating the shape of the one or more clusters to a model having a given shape and generates the cut filter including a region of interest of a shape of the approximated model.

16. The information processing method according to claim 13, further comprising:
executing a filtering process for the first events transmitted from the sensor using the cut filter and the pass filter.

17. The information processing method according to claim 16, further comprising:
performing filtering for an event of a sensor value that is outside the region of interest of the cut filter in accordance with the region of interest of the pass filter.

18. The information processing method according to claim 13, further comprising:
transmitting the generated cut filter to the sensor or a communication apparatus in which the sensor is incorporated.
